(19) United States
(12) Patent Application Publication
(10) Pub. No.: US 2016/0350830 A1
(43) Pub. Date: Dec. 1, 2016

(54) NETWORK-BASED USER-TO-USER TRADING

(71) Applicant: Ehab Youssef, Los Gatos, CA (US)

(72) Inventor: Ehab Youssef, Los Gatos, CA (US)

(21) Appl. No.: 15/161,209

(22) Filed: May 21, 2016

Related U.S. Application Data
(60) Provisional application No. 62/230,282, filed on Jun. 1, 2015.

(51) Int. Cl. G06Q 30/06; H04W 4/02; H04W 4/00

(52) U.S. Cl. CPC G06Q 30/0623; H04W 4/008; H04W 4/023

(57) ABSTRACT

Products, goods or services are exchanged, traded or bartered through double-blind transactions facilitated by a network site. Proposed transactions are listed, offered and accepted by counter party users of the network site. Proposed transactions may include payment of money, in whole or in part, in addition to the exchange, trade or barter of products, goods or services. The exchange, trade or barter is facilitated by a third-party agent, which may provide ancillary products, goods or services, within the expertise of the agent. The network site or the agent may facilitate payment of money. Automobiles, jewelry, vacation rentals, and work on a house are some products or services that can be exchanged, traded or bartered. Coffee shops, libraries, auto dealers, travel agents, hardware stores, and lockers are some facilitating agents.

This application claims the benefit of U.S. Provisional Application No. 62/230,282, filed Jun. 1, 2015.

### FIELD OF THE INVENTION

The present invention is in the field of Internet commerce, particularly user-to-user trading.

### BACKGROUND

Online commerce is essential to the modern economy. It allows people, who otherwise would not interact with each other, to benefit from buying, selling, and exchanging products, goods, and services at fair valuations and prices, the realization of which requires the broad sharing of information.

Online retailers, such as Amazon®, only list products for direct sale by themselves or for sale by a limited number of approved retail partners. Furthermore, they tend to offer mass-produced products and not one-of-a-kind, custom or previously-owned products.

Online auction websites such as eBay® and online classified advertisements websites such as Craigslist® list one-of-a-kind, custom or previously-owned products for user-to-user sales and secure exchange of money, but do not provide for valuation, certification or shipping by an independent expert. Furthermore, they require one user to provide personally-identifiable information, including a shipping address, to another user. They do not provide for convenient, safe and secure drop-off/pick-up locations.

Online review websites such as Yelp® list services for sale, but only from a limited number of approved partners. Furthermore, they do not provide for secure exchange of money and do not mask users' identities.

Swap websites such as U-Exchange provide for non-cash user-to-user trades and bartering, but do not mask users' identities and do not provide for valuation, certification or shipping by an independent expert. Nor do they provide for convenient, safe and secure drop-off/pick-up locations.

What is needed is a way for users to exchange, trade or barter for products, goods or services, including one-of-a-kind, custom or previously-owned products or goods, without revealing the personally-identifiable information of the transacting parties to each other, a way to have products, goods or services evaluated or certified by an independent expert, a way to receive ancillary value-added products, goods or services in conjunction with the exchange, a way to conveniently, safely and securely deliver or receive the products, goods or services and a way to exchange money securely.

### SUMMARY OF THE INVENTION

The present invention is directed to double-blind offer and acceptance of products, goods or services, online, through an electronic network such as the Internet. The anonymity of such networks enables the double-blind nature of swapping according to some embodiments of the invention. Some embodiments provide for exchanging, trading or bartering. Some embodiments provide for an independent expert evaluating or certifying products, goods or services. Some embodiments provide for an independent third-party to provide value-added products or services in conjunction with the exchanged, traded or bartered items. Some embodiments provide a way to conveniently, safely and securely deliver or receive items. Some embodiments provide for exchange of money in conjunction with the exchanging, trading or bartering of items.

### BRIEF DESCRIPTION OF THE DRAWINGS

FIG. 1 illustrates an electronic network of computers and a network site server.

FIG. 2 illustrates a method of listing a product or service exchanged, traded or bartered through an agent.

FIG. 3 illustrates a transaction according to an embodiment of the invention.

FIG. 4 illustrates a transaction with exchanging, trading or bartering according to an embodiment of the invention.

FIG. 5 illustrates a transaction with exchanging, trading or bartering and a rejected offer according to an embodiment of the invention.

FIG. 6 illustrates a process in which an agent pays to be listed for referrals according to an embodiment of the invention.

FIG. 7 illustrates a process in which an agent pays for referrals received according to an embodiment of the invention.

FIG. 8 illustrates a process in which an agent reviews a service sample according to an embodiment of the invention.

FIG. 9 illustrates a transaction with a trade-in and upgrade service according to an embodiment of the invention.

FIG. 10 illustrates a locker and lock mechanism for user to user trading according to an embodiment of the invention.

FIG. 11 illustrates a shopping mall with a locker bank in a not-easily-observed area, monitored by surveillance cameras, according to an embodiment of the invention.

### DETAILED DESCRIPTION

The invention disclosed herein involves facilitating, using a network site, the transfer of products, goods or services between users in a double-blind manner. Various embodiments handle information transferred through electronic networks using electromagnetic signals. Types of electronic networks include wired networks, fiber-optic networks, and networks of mobile devices and base stations connected through wireless links. The Internet is an example of an appropriate network for such facilitation. A “network site” is a centralized resource in an electronic network that is access-managed through a computer or computer program. Network sites run on servers. Servers keep lists of goods and services in databases, lists of users, and lists of agents in databases that allow fast access, mapping, searching, sorting, and filtering of results. Products, goods or services are anything of economic value. Some examples are automobiles, jewelry, vacation rentals, and house painting.

The present invention can be embodied in computer-readable storage media that store computer code. According to such an embodiment, when a server computer runs the code it behaves as a network site. It is able to receive inquiries from users in the form of requests through the network. Based on the request, the server queries a database of products, goods, or services. In some embodiments the server stores the database. In some embodiments the database is separate from the server. If the database contains a product, good or service that matches the request from the inquiring user then it responds to the query with an identifier of a user who posted the product, good or service. The network site receives the identifier from the database query response.

According to such an embodiment, the server queries a database of independent agents. In some embodiments, the server stores the database. In some embodiments the database is separate from the server. Agents are independent in that they are do not own or control the server and they are not owned or controlled by the owner of the server. The database returns the contact information of an appropriate agent. Many different algorithms are appropriate for selecting a best agent. In various embodiments, criteria used for the selection can include the location of the inquiring user, the location of the posting user, the proximity between the inquring user to the posting user, the proximity between the inquring user and/or the posting user to the agent, the skill set of the agent, and an amount of money paid or offered by the agent. An agent can be any entity and each agent may have an unlimited number of physical locations to receive, deliver from, evaluate and/or certify products, goods and services.

According to such embodiments, the server sends a response to the inquiring user indicating the name and address of the agent. The server also sends a message to the posting user with the name and address of the agent. In some embodiments the server also enables the posting users to arrange a time to deliver the product or good to the agent, and subsequently a time for the inquiring user to pick up the product or good from the agent. In the case of services, according to some embodiments, the server enables the inquiring user to arrange a time to deliver an item to the agent, and subsequently a time for the posting user to access the item to provide a service on the item.

According to some embodiments, the network site provides for the inquiring user to make an offer to the posting user. The offer can be for any consideration that the inquiring user wishes to provide. The consideration could be a monetary payment, or could be any other product, good or service. In some embodiments the network site offers to accept credit card payments in order to facilitate the exchange of monetary consideration. According to some embodiments, the posting user posts a request for a product, good or service. The user may post the request alone, or the user may post the request in combination with an offer. For example, a user may post a request for a certain kind of car or the user may post a request for that kind of car in combination with an offer to sell a different kind of car.

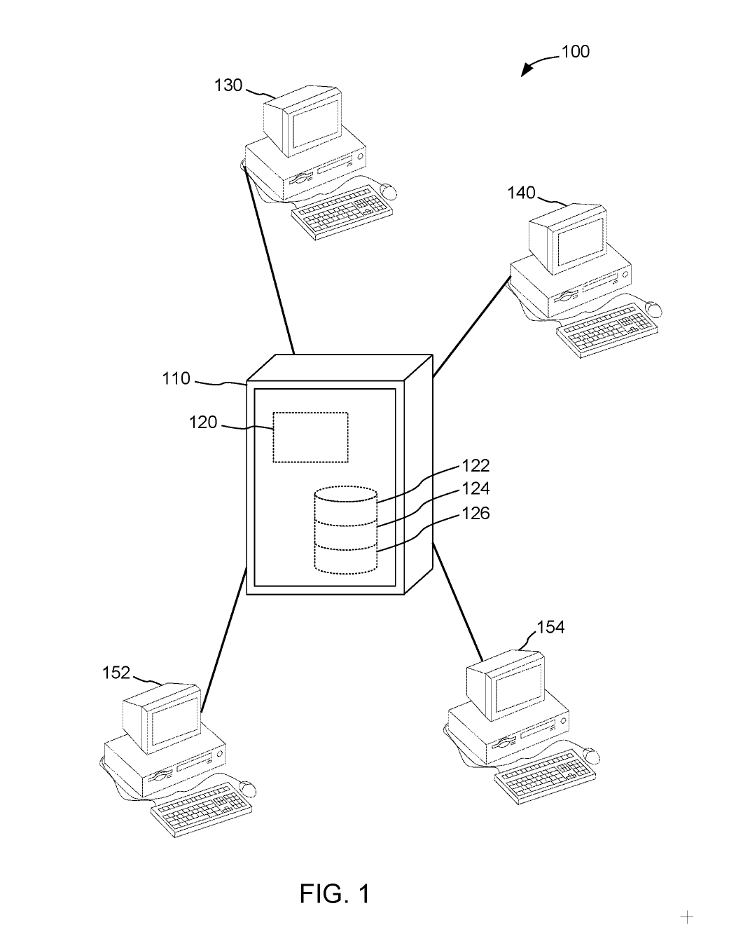

FIG. 1 shows electronic network 100 according to an embodiment of the invention. Server 110 hosts network site 120, goods and services database 122, user database 124, and agent database 126. Computer 130 provides management of network site 120 and the databases through server 110. Network site 120 uses the databases to provide listings of goods and services. Agent computer 140 accesses network site 120 through server 110. User computer 152 and 154 access network site 120 through server 110.

Some embodiments of the invention provide for a showing of a service sample. A service sample is any object or act that illustrates an expectation of the result of a service. Some examples of service samples are demonstrations, complete objects, photos showing the result of a completed service, or videos of the proposed service being performed. For example, a window cleaning service could provide service samples in the form of a cut-away portion of a window and frame with clean corners, a demonstration of spraying and wiping a window, a photo of a clean window, or a video of workers cleaning the windows of a house.

In the embodiment of FIG. 1, in one usage scenario a user of computer 154 accesses the network site 120, which reads a video file from goods and services database 122 and sends it to computer 154. Computer 154 proceeds to play the video on its display screen. In another usage scenario of the embodiment, a user of computer 154 provides an address and requests a sample of a polished stone from network site 120, which transmits the request to agent computer 140. The agent of agent computer 140 completes the request by sending a single polished stone, by postal mail, to the user of computer 154.

According to aspects of the invention, a first user, herein referred to as User A, proposes a transaction by posting, on a network site, an offer of a product, good or service that User A desires to buy, sell, or trade. Posting involves providing information, such as a title, a description, a set of photos, a video, and an estimated value or desired price. Users provide information through any conventional human-computer interface methods, such as typing on a keyboard, clicking a mouse, tapping a screen, and speaking to a speech-recognition system.

The network site stores the information of the posting in goods and services database 122, and the identifying information of the user in user database 124. The network site lists the posted offer, but no information that another user could use to identify User A. That means no mailing address, no phone number, no email address, no user ID, and no nickname. In one scenario, a second user, herein referred to as User B, is interested in accepting the offer. The network site also does not list any personally identifiable information of User B. The network site informs User A and User B of a third-party agent willing to facilitate the transaction. According to various embodiments, the network site informs each user by their preference of sending an email, sending a text or SMS message, calling a telephone number with a recorded message, or providing a notification message in an app or web browser.

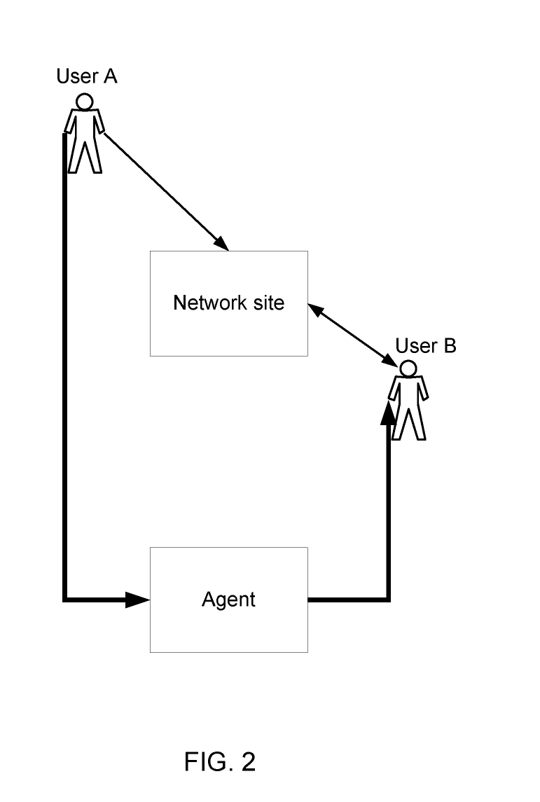

FIG. 2 shows an embodiment of the invention. For transactions according to the embodiment, first User A lists a product, good or service on a network site, which identifies an agent. User B views the listing on the network site, which identifies the agent. User A provides the product, good or service, through the agent, to User B.

Some embodiments of the invention provide for transactions in which User A offers a product, good or service that the User A can provide and lists a product, good or service that User A wishes to receive. User B accepts the offer if User B is able to provide the product, good or service that User A wishes to receive. In some such transactions, the products, goods or services exchanged are of approximately equal value. In other transactions, the values are unequal, but the user with the less valuable product, good or service provides a payment of money of an amount equal to the difference in value of the products, goods or services to be exchanged. In some such embodiments, the network site accepts payments from one user and provides payment to the other user, either with or without a service fee.

In some embodiments, when the network site informs User A and User B of an agent, it merely provides the name and contact information of the agent. In some embodiments, the network site is able to receive a message from User B accepting or declining the offer from User B. When the network site receives such a message, it notifies User A. Some embodiments allow for User B to accept an offer conditionally, based on a condition such as a minimal value identified by an appraisal by the agent.

In some embodiments the network site notifies the agent of the proposed trade. In various embodiments the network site provides notification as an email, as a text or SMS message, as an automated phone call, or as a notification message on an app or web browser. In some embodiments the network site refers User A and User B to the agent and User A and User B contact the agent independently. In some embodiments the agent intermediates the exchange of the product, good or service between User A and User B. In some such embodiments, the intermediation encompasses the exchanging of money.

Different agents are appropriate for different types of products, goods or services. For example, coffee shops or public libraries are convenient, safe, secure, public places for the exchange of small products and goods or simple services. For vacation rentals, a travel agency would be an appropriate agent. For jewelry, a jewelry store or jewelry repair shop would be appropriate. For house repair or maintenance services a hardware retailer or contractor's office would be appropriate. For automobiles an auto dealer, repair shop, auto body shop, or tire shop would be appropriate. These are examples, and do not limit the scope of the invention.

In some embodiments, the agent may provide products, goods or services that are ancillary to the exchange between users. Some examples of ancillary products, goods or services are title search, appraisal, cleaning, maintenance, repair, transport, tire replacement, painting, warranty, accessories and trade-in or upgrade services.

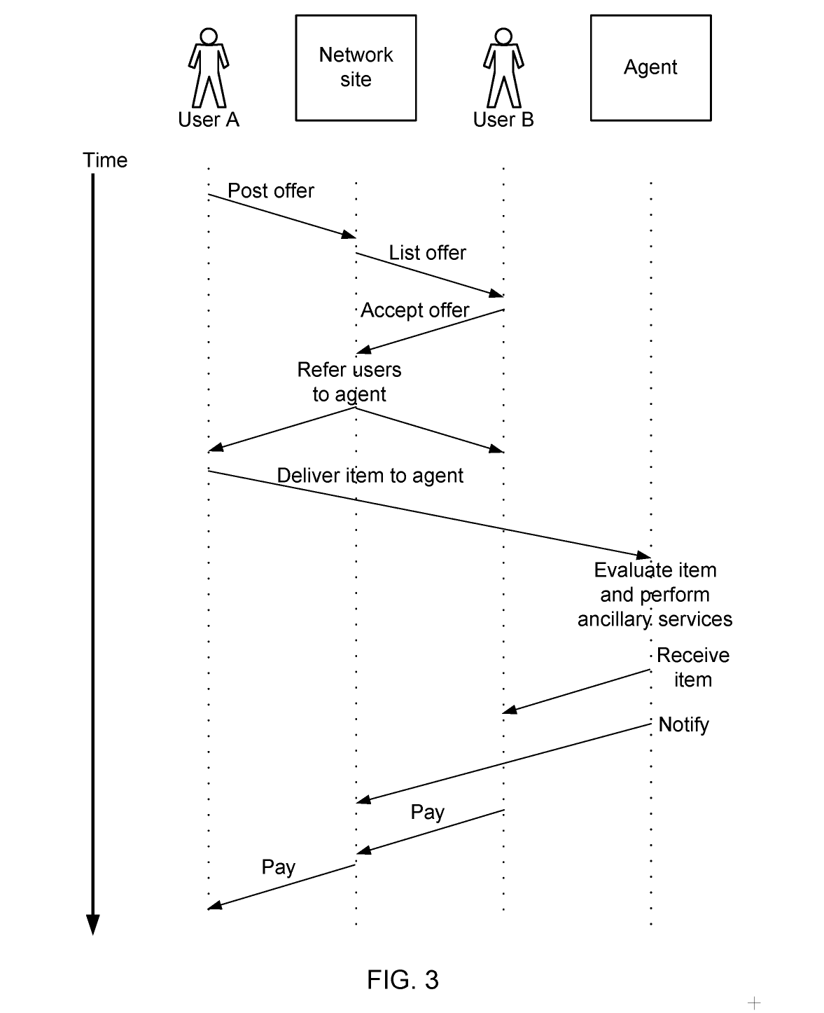

FIG. 3 shows a transaction performed by one embodiment of the present invention. The order of events from top to bottom indicates their chronological order. First, User A posts an offer of a product, good or service by entering a description and uploading a video using computer 152. The network site lists the product good or service by storing it in database 122. User A can provide such product, good or service. User B sees the listing on the screen of computer 154 by searching the network site. Satisfied with the description, user B accepts the offer. The network site gives both User A and User B a referral to an agent. Next User A delivers the product, good or service sample to the agent. The agent evaluates the product, good or service sample and performs ancillary services on it. Next the agent delivers, or has delivered, the product, good or service to User B, or makes it available for User B to pick up or receive. The agent notifies the network site and User B makes payment, via a server, to the network site responsible for the offer and acceptance services. In turn, the network site pays User A.

No user exchanges payment with the agent. However, in some embodiments agents benefit from increased traffic to their brick and mortar shops. Consider users who exchange baseball cards using a coffee shop as an agent. Though serving coffee is not an ancillary product, good or service, the coffee shop is likely to sell a coffee to either User A or User B with a profit greater than the cost of facilitating a baseball card swap.

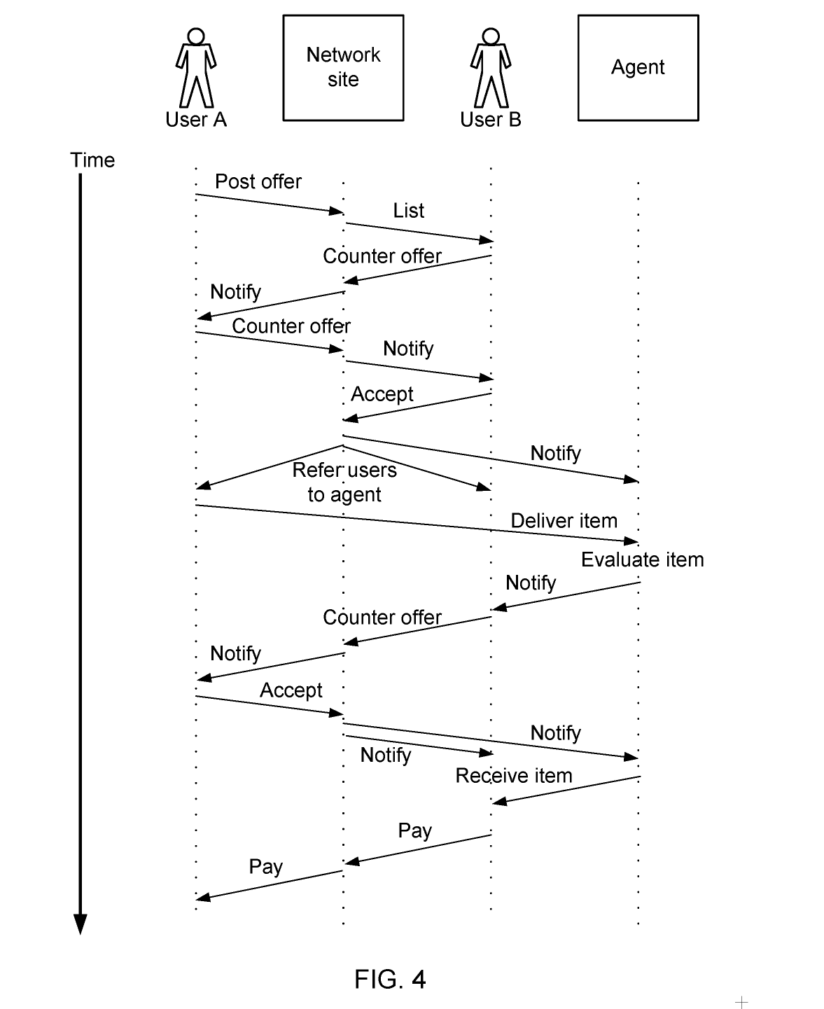

FIG. 4 shows a transaction performed by one embodiment of the present invention. First, as in the transaction of FIG. 3, User A posts an offer of a product, good or service, which the network site lists. User B sees the listing and provides a counter offer to the network site. The network site notifies User A, who responds with another counter offer. The network site notifies User B of the counter offer. In various scenarios any number of cycles of counter offers can occur. Eventually, User B accepts the counter offer. The network site notifies an agent of an expected exchange, then notifies User A and User B of the agent. User A delivers the product, good or service to the agent. The agent evaluates the product, good or service sample and notifies User B of an estimated value. User B makes a resulting counter offer to the network site, which notifies User A. According to various scenarios, another round of counter offers can occur. Eventually User A accepts the counter offer. The network site notifies both the agent and User B. User B receives the product, good or service and submits payment to the network site. The network site deducts a commission from the payment and finally submits a payment to User A.

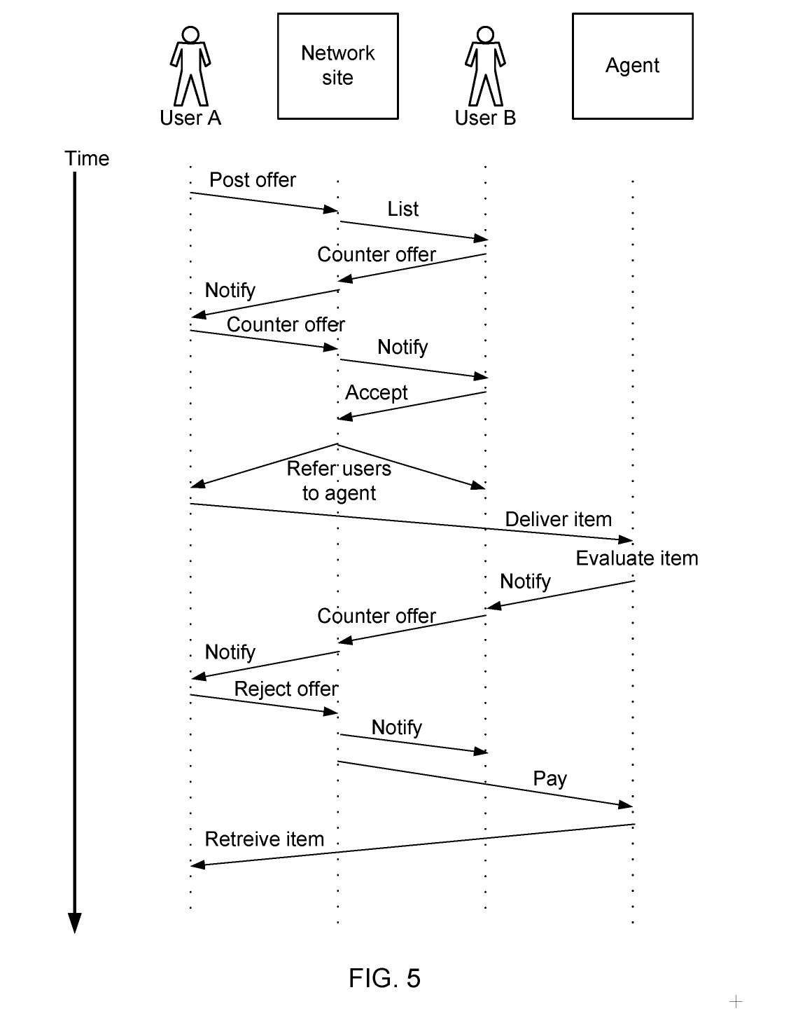

FIG. 5 shows a transaction performed by one embodiment of the present invention. The transaction begins exactly as the transaction of FIG. 3. However, the agent stands continuously ready to facilitate the trade, barter or exchange, and so the network site does not notify the agent.

Furthermore, in the scenario of FIG. 5, User A rejects the counter offer of user B after the agent evaluated the item. The network site notifies User B of the rejection. According to this embodiment, the network site responsible for the offer and acceptance services pays the agent for the work performed in evaluating the product, good or service. Finally, User A retrieves the item from the agent.

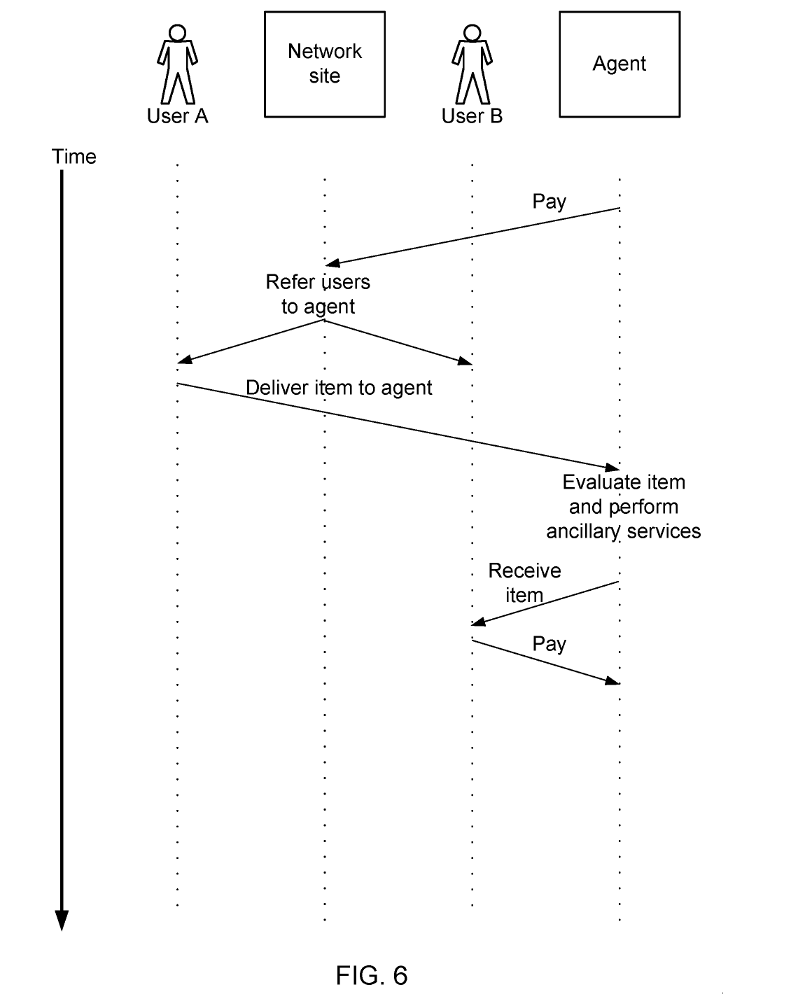

FIG. 6 shows a transaction performed by an embodiment of the invention. The agent pays the network site to be considered for referrals. The network site then refers User A and User B to the agent. User A delivers a product, good or service to the agent. The agent evaluates the product, good or service and performs ancillary services for User B. User B receives the product, good or service and pays the agent.

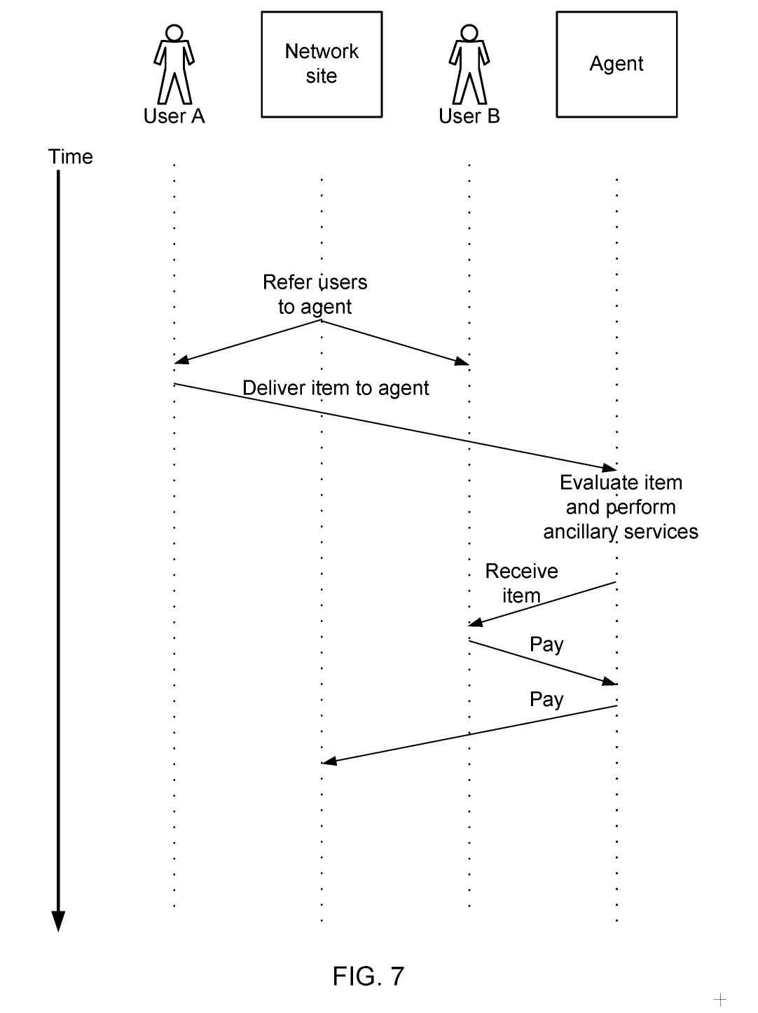

FIG. 7 shows a transaction performed by an embodiment of the invention. The network site refers User A and User B to the agent. User A delivers a product, good or service to the agent. The agent evaluates the product, good or service and performs ancillary services for User B. User B receives the product, good or service and pays the agent. Following payment from User B, the agent proceeds to pay the network site responsible for the referral.

As illustrated, exchange of money, in consideration of the full or partial value of a product, service or good, can be handled in several ways. In some embodiments User A pays the network site responsible for the offer and acceptance services, and in some embodiments User A does not. In some embodiments User B pays the network site responsible for the offer and acceptance services, and in some embodiments User B does not. In some embodiments User A pays the agent and in some embodiments User A does not. In some embodiments User B pays the agent, and in some embodiments User B does not. In some embodiments the network site responsible for the offer and acceptance services or the agent takes a commission or transaction fee, and therefore pays User A less than User B paid.

In some embodiments the agent pays the network site responsible for the offer and acceptance services to be available for referrals. In some embodiments the agent pays the network site responsible for the offer and acceptance services for each referral. In some embodiments the network site responsible for the offer and acceptance services pays the agent for being available to facilitate transactions and offer ancillary services. In some embodiments no money is exchanged between the network site responsible for the offer and acceptance services and agents.

In some embodiments, the network site provides listings to third-party network sites such as sites for social networking, classifieds, or auctions. Such third-party network sites may pay the network site for the listing traffic.

In an embodiment directed specifically to trading motor vehicles, User A posts, on a network site, an offer to sell or trade a vehicle at a specified valuation. The network site lists the vehicle and valuation. User B views the listing and accepts the offer, conditioned upon a successful evaluation by an auto dealer. User A brings the vehicle to the auto dealer. The auto dealer performs a title search and searches a database of vehicle information. The auto dealer inspects the vehicle for safety and reliability and may certify the vehicle. The auto dealer also appraises the value of the vehicle. If the auto dealer confirms that the value assigned by User A is reasonable and that the vehicle is safe and sufficiently reliable and that the title is clean, then the auto dealer informs the network site, and the network site invites User B to accept the vehicle, either with or without a personal inspection and test drive by User B at the auto dealer location. The auto dealer offers to User B to repair scratches and dents, to change the oil if needed, to change the tires and brakes if needed, to add accessories, and to add a warranty. User B accepts the vehicle and may choose to accept parts and services from the auto dealer. Upon acceptance of the vehicle by User B, the auto dealer pays a referral fee to the network site, User B pays the network site responsible for the offer and acceptance services for the value of the vehicle, and the network site responsible for the offer and acceptance services pays User A for the value of the vehicle.

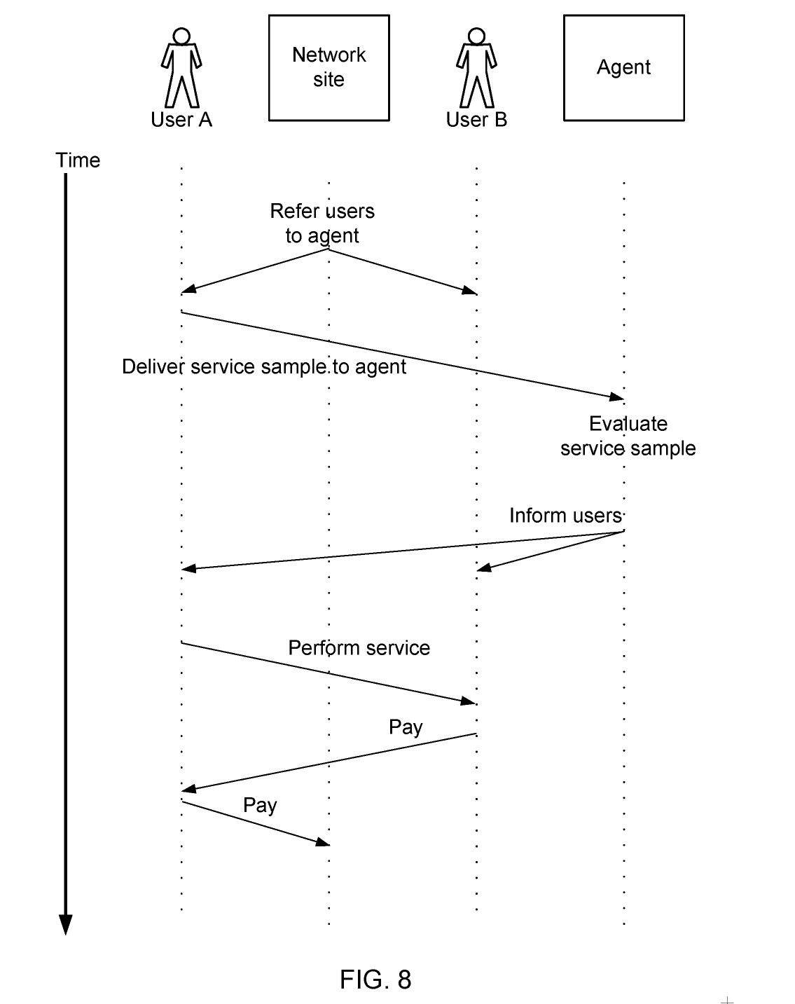

FIG. 8 shows a transaction performed by an embodiment of the invention. The network site refers User A and User B to the agent. User A delivers a service sample to the agent. The agent evaluates the service sample. If the agent deems the service sample acceptable, based on attributes such as quality and price, the agent informs both User A and User B. User A proceeds to perform the service, after which User B pays User A for the service, and User A pays the network site for the referral.

According to some embodiments, the agent arranges a time and place for User B to drop off an item for service. The agent further arranges a time and place for user A to perform the service. Then the agent arranges a time and place for user B to pick up the serviced item. In some embodiments the network site facilitates the scheduling of time and place.

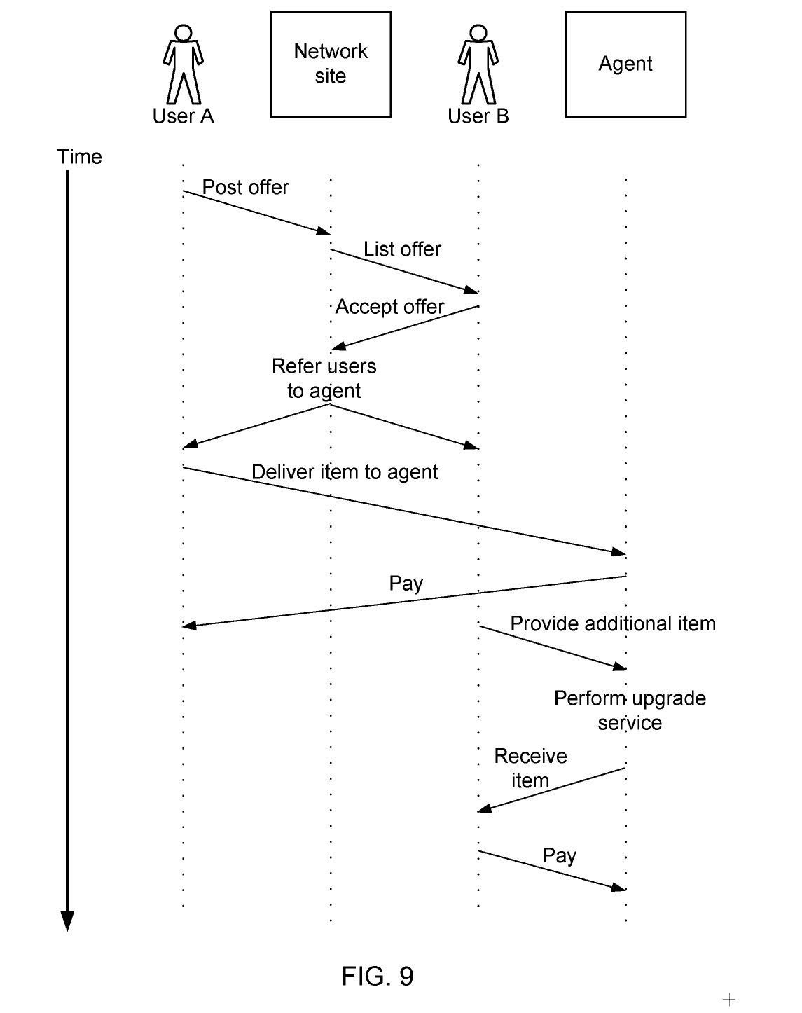

FIG. 9 shows a transaction performed by an embodiment of the invention. User A posts an offer of a product, good or service, which the network site lists. User B accepts the offer, after which the network site refers User A and User B to an agent. User A provides the product, good or service to the agent. The agent accepts the product, good or service and pays User A. User B provides an additional product, good or service, which the agent accepts. The agent provides an upgrade service to the product, good or service from User A. User B receives that product, good or service, and pays the agent an amount equal to the value of the product, good or service from User A, plus the value of the upgrade service, less the value of the product, good or service that User B provided to the agent.

This scenario would be typical of a used car dealership facilitating a sale of a vehicle from User A to User B while accepting a trade-in from User B and performing service on the vehicle from User A.

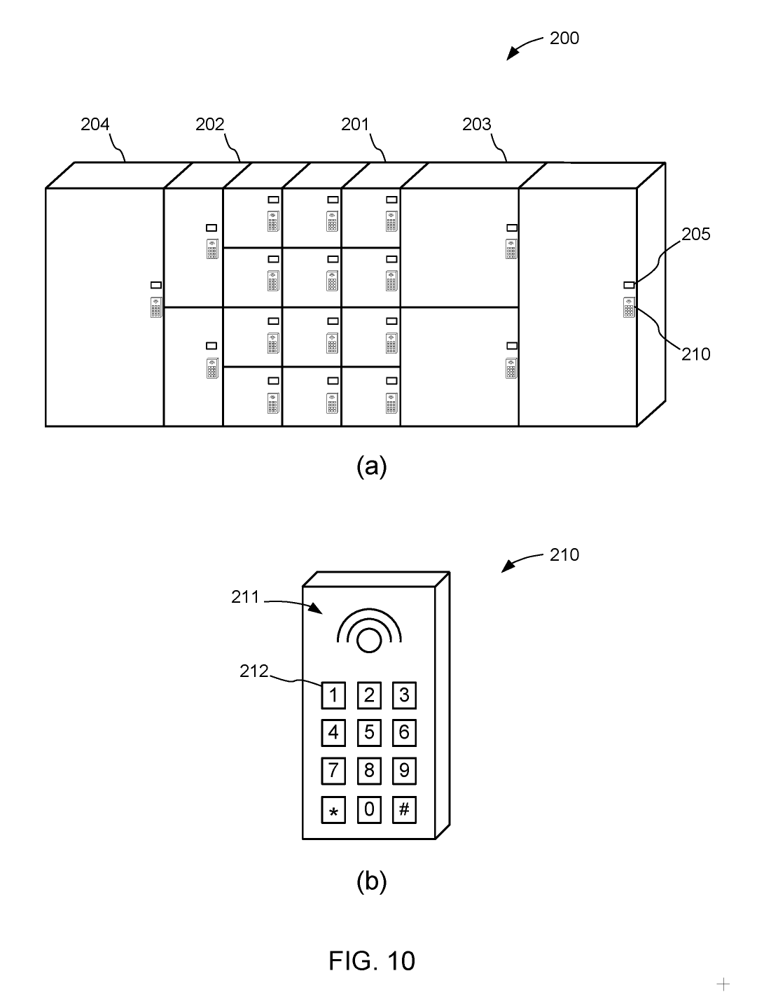

FIG. 10(a) shows a mechanism for facilitating user to user trading according to an embodiment of the invention. The mechanism is a bank of lockers 200 that stand about 2.25 meters (approximately 7 feet) high. It has twelve small sized lockers 201, two medium sized lockers 202, two large sized lockers 203, and two extra-large sized lockers 204. Various embodiments have different numbers, sizes, and varieties of sizes of lockers. Each locker is labeled with a unique number 205. Each locker is secured by a locking mechanism 210.

FIG. 10(b) shows locking mechanism 210. It has a near-field communication (NFC) sensitive area 211, which can communicate with handheld devices such as mobile phones. The handheld device sends a signal to the NFC area with a code received from the network site. To enable users without a NFC-enabled device to access the locker, locking mechanism 210 has a keypad with buttons 212 that a user can use to enter a code to open the locker. Two pseudorandom codes, a function of the current time and a unique ID for each locker, are valid at any moment. Each code remains valid for 10 minutes before being replaced by another code. The expirations of the codes are staggered by 5 minutes. When a network site gives access to a user by sending one of the two codes, the network site sends the newest code. Thereby, the user has a period of 5 to 10 minutes in which to open the locker with the keypad before having to request a new code from the network site.

According to some embodiments as shown in FIG. 10, once User A and User B agree to a price of an item through the network site, the network site informs User A of the location of locker bank 200, the label number of a presumably unoccupied specific locker, and a door opening code. The network site provides the information by sending it to a mobile device. User A finds the locker, opens it, places the item inside, closes, latches the locker, and sends a message to the network site through a mobile phone app. After about an hour, the network site sends a message to User B through a mobile phone app with the location of the locker bank, the label number of the locker presumably containing the item, and a door opening code. User B finds the locker, opens it, retrieves the item, and sends a message to the network site confirming receipt of the item. At that time the network site charges an account associated with User B, keeps a portion of the charge, and credits the remainder to an account associated with User A.

If User B finds that the locker does not contain the item or that the item is not what User A described, then User B can leave the locker as it was and send a message to the network site informing of the situation. Locker bank 200 according to such embodiments must be installed in a location that is recorded from multiple directions by surveillance cameras accessible by the network site. If User B indicates that the item is not present, an operator of the network site reviews the surveillance video from when User A was at the locker and from when User B was at the locker to check for foul play.

Though surveilling for foul play is important to the system, to maintain the anonymity of users, it is best to install locker bank 200 in a location that is not easily observed by bystanders.

Convenience stores can benefit from installing such locker banks since they would attract to the store users who would be likely to purchase other goods from the store. Jewelry stores can benefit from installing small, but particularly strong lockers since they would attract to the store users who would be likely to purchase other jewelry items or services such as polishing and resizing. Shopping malls can benefit from installing such locker banks. Many retail facilities can benefit from installing user to user trading lockers.

Car washing facilities can benefit from installing such lockers and having them available only for trading auto-related accessory items since users trading auto-related accessory items are likely to want a car washed. Sports equipment stores can benefit from installing such lockers and having them available only for trading sports-related items. The network site assigns User A locker space in a location that depends on the type of item that User A is offering. Thereby, the network site maximizes the probability of ancillary purchases from the hosting business.

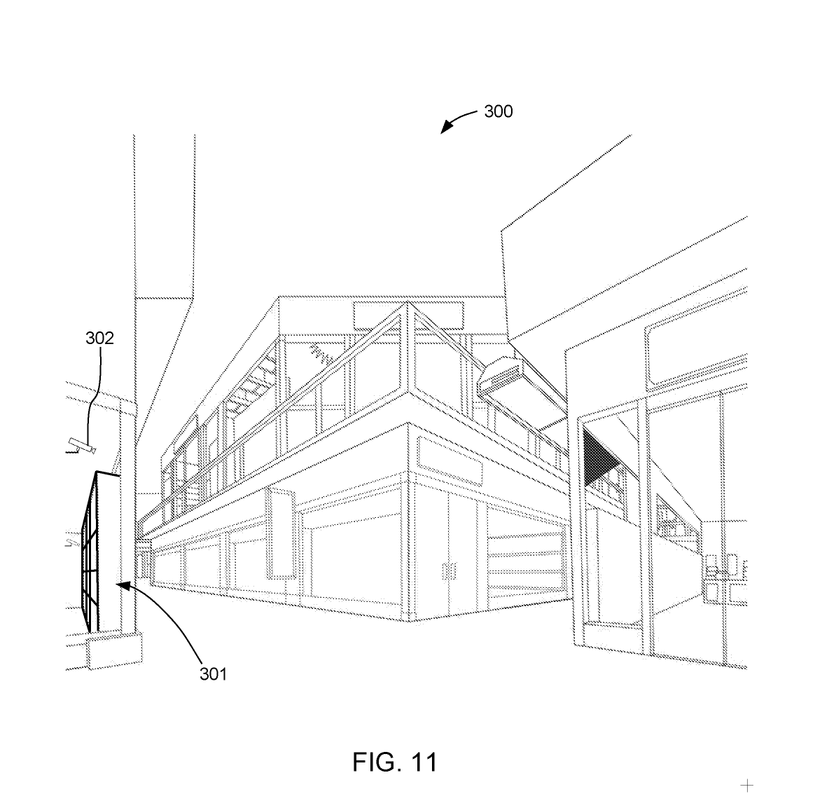

FIG. 11 shows a shopping mall 300. It comprises a locker bank 301 in a location that is not easily observed by bystanders. Locker bank 301 is monitored by surveillance cameras 302.

Network sites, according to some embodiments of the invention, offer, as a premium service, the right for User A to store items in a locker before reaching a trading agreement with a User B. The network site charges User A a rental fee to cover the time-value of storing the item. In such a case, if User A fails to pay rent, the network site gradually reduces the offer price of the item until a User B accepts the offer to purchase the item. After the purchase, the network site keeps the amount of the purchase price.

Some embodiments of physical machines described and claimed herein are programmable in numerous variables, combinations of which provide essentially an infinite variety of operating behaviors. The behavior of either or a combination of humans and machines; instructions that, if executed by one or more computers, would cause the one or more computers to perform methods according to the invention described and claimed; and one or more non-transitory computer readable media arranged to store such instructions embody methods described and claimed herein. Each of more than one non-transitory computer readable medium needed to practice the invention described and claimed herein alone embodies the invention.

Additionally, such equivalents include both currently known equivalents and equivalents developed in the future, i.e., any elements developed that perform the same function, regardless of structure. The scope of the invention, therefore, is not limited to the exemplary embodiments shown and described herein.

In accordance with the teaching of the invention a computer and a server are articles of manufacture. Other examples of an article of manufacture include: an electronic component residing on a mother board, a mainframe computer, or other special purpose computer each having one or more processors (e.g., a Central Processing Unit, a Graphical Processing Unit, or a microprocessor), configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code is encoded in a non-transitory computer readable medium of the computing device. The processor or a module, in turn, executes the computer readable program code to create or amend an existing computer-aided design using a tool.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof.

What is claimed is:

1. A method of facilitating trading, exchanging or bartering of products, goods or services using a server, the method comprising:
storing, on a non-transitory computer-readable medium, a database of at least one item offered by a first user;
sending, through an electronic network, a description of at least one item from the database;
receiving, from the electronic network, an inquiry for at least one item from a second user; and
sending one or more messages through the electronic network informing the first user and the second user of a facilitating agent,
wherein the first user is unable to identify the second user and the second user is unable to identify the first user.

2. The method of claim 1 wherein the inquiry includes an offer for a reciprocal product, good or service.

3. The method of claim 1 further comprising arranging with the facilitating agent for the facilitating agent to evaluate the product, good or service.

4. The method of claim 3 wherein the facilitating agent evaluates the service based on a service sample.

5. The method of claim 1 further comprising:
accepting payment from one of the first user or the second user; and
providing payment to the other of the first user or the second user.

6. The method of claim 1 further comprising charging at least one of the facilitating agent, the first user, and the second user.

7. The method of claim 1 further comprising providing the listing to a third-party network site.

8. The method of claim 1 further comprising receiving a confirmation of ownership title from the facilitating agent.

9. The method of claim 1 further comprising allowing at least one of the first user and second user access to the product, good or service via the network site free of charge.

10. The method of claim 1 further comprising indicating acceptance of the offer.

11. The method of claim 10 wherein the acceptance is conditional.

12. A method of facilitating trading, exchanging or bartering comprising:
receiving an automatically generated message notification from a network site of a proposed trade, exchange or barter of a product, good or service; and
evaluating the product, good or service.

13. The method of claim 12 further comprising paying for the notification.

14. The method of claim 12 further comprising performing a title search.

15. The method of claim 12 further comprising certifying the product, good or service.

16. The method of claim 12 further comprising enhancing the product, good or service.

17. The method of claim 12 further comprising charging a trading party.

18. At least one non-transitory computer-readable medium storing code that, if executed by at least one server computer would cause the at least one server computer to:
receive a request from an inquiring user for a particular product, good, or service item;
query a database of a multiplicity of product, good or service items, each associated with a posting user;
receive the identity of a posting user associated with the particular product, good or service item;
query a database of a multiplicity of independent agents;
receive the identity of an independent agent;
send a response to the inquiring user, the response identifying the independent agent; and
send a message to the posting user, the message identifying the independent agent,
whereby the posting user is unable to identify the inquiring user and the inquiring user is unable to identify the posting user.

19. The at least one non-transitory computer-readable medium of claim 18 that would further cause the at least one server computer to:
receive an offer from the querying user for a particular consideration; and
send a message to the posting user, the message identifying the offered consideration.

20. A retail facility comprising at least one locker, itself comprising a locking mechanism, the locking mechanism being enabled to unlock the locker in response to entry of a code received from a mobile device.
